(19) United States
(12) Patent Application Publication
(10) Pub. No.: US 2002/0010557 A1
(43) Pub. Date: Jan. 24, 2002

(54) Imminent icing condition enunciator

(76) Inventor: Wayne L. Mann, Tualatin, OR (US)

Correspondence Address: DELLETT AND WALTERS, 310 S.W. FOURTH AVENUE, SUITE 1101, PORTLAND, OR, 97204, US

(21) Appl. No.: 09/866,449

(22) Filed: May 25, 2001

Related U.S. Application Data
(63) Continuation of application No. 08/738,180, filed on Oct. 28, 1996.
Application No. 08/738,180 is a continuation of application No. 08/408,694, filed on Mar. 21, 1995, now abandoned.

(51) Int. Cl. G06F 19/00

(52) U.S. Cl. 702/32

(57) ABSTRACT

An imminent icing condition enunciator employs an infrared sensor with a focusing element to receive ambient infrared energy from a surface, particularly a road surface, and the output of the sensor is processed to provide an indication of imminent icing to the operator of, for example, an automobile or other vehicle. The device is suitably mounted to a vehicle, within a mirror enclosure so as to provide an unobstructed view of the roadway surface.

This invention pertains to sensing of temperature and more particularly to sensing of temperature or icing conditions of a surface and providing an indication of imminent icing conditions.

### BACKGROUND OF THE INVENTION

The detection of icing on a surface is desirable and of advantage in many applications. For example, detection of icing conditions on roadways would enable a driver to be informed that ice is present on the roadway so the driver could to accordingly adjust the style of driving or discontinue driving altogether before an accident occurs.

Heretofore, various methods have been employed to attempt detection of icing. These methods have included placing temperature sensors near the road surface to provide ambient temperature reading. Often such detectors were combined with moisture detectors and a decision was made as to icing based on the presence of moisture and the ambient temperature. However, such methods are not always able to accurately predict icing since the ambient air temperature may be greatly different than the temperature of the road surface wherein the road surface may actually be in an iced state while the air temperature is somewhat above freezing. Inaccurate determinations can lead to an operator ignoring an icing detector's warning if the operator knows that the indicator does not provide an accurate warning at all times.

Other methods have employed a radiation source directed towards the roadway with a receiver in spaced relation to the transmitter so as to receive reflections from the road surface of the energy transmitted from the radiation source. Surface condition predictions were then made based on the absorption and reflection of the energy by the road surface. However, the use of a source and reflected energy reception complicates the installation of such a device and requires that both the source and the receiver be maintained in a clean state, free from dirt or other road debris which would obscure the emitter or receiver.

In aircraft applications, the ability to detect wing icing is of utmost importance, since ice formations on wings can degrade the aircraft's lift-to-drag ratio. Aircraft currently have a device to measure air temperature, called an OAT (outside air temperature) sensor. This instrument provides the pilot with temperature information all of the time, whether the aircraft is in the hanger, loading passengers, flying in clear air or penetrating an icing thunder head. Therefore, in cold weather, the OAT sensor could indicate freezing continuously whenever the temperature was below freezing. Such indications can be of limited usefulness since the OAT makes no environmental distinction and is therefor of limited assistance in detecting icing during night flights, for example, when pilots are unable to visually inspect wing surfaces for ice accumulation.

The ability to detect icing conditions, particularly to detect imminent icing conditions, wherein an indication is provided that surface conditions of a roadway, for example, are close to the icing point is highly desirable and can greatly reduce the likelihood of accidents.

### SUMMARY OF THE INVENTION

The invention accordingly provides an icing detector for determining icing conditions of a surface, wherein an infrared sensor is positioned in spaced relation to the surface for detecting ambient infrared emissions from the surface and processing circuitry is provided for receiving the detected ambient infrared emissions and for determining the likelihood of icing conditions of a surface based on the received infrared radiation.

The device also may include filtering members for ensuring that only selected wavelength energy reaches the sensor and for blocking the passage of other wavelengths, to reduce the likelihood of sensor overload. A focusing system is also provided to enable the infrared energy from a precise surface position to be focused onto the sensor, thereby ensuring that the ambient radiation from a particular surface is detected and to further reduce the likelihood of background infrared radiation affecting the sensor.

It is accordingly an object of the present invention to provide an improved icing detector for determining the likelihood of icing on a surface.

It is another object of the present invention to provide an improved roadway icing condition detector suitable for use with a vehicle.

It is still a further object of the present invention to provide an improved system for warning drivers of the likelihood of icing conditions on the roadway surface.

It is yet another object of the present invention to provide an improved imminent icing sensor which is of relatively low cost.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of an imminent icing system according to the present invention;

FIG. 2 is a sectional view of a particular embodiment of a sensor head according to the present invention, adapted for mounting to an external member of a vehicle;

FIG. 3 is a perspective view of the sensor body of FIG. 2;

FIG. 4 is a sectional view of a protective device adapted to mount to the sensor head of FIG. 2, for assisting in maintaining the viewing window in a clean condition;

FIG. 5 is a cutaway view of a passenger car mirror enclosure with a sensor according to the present invention installed therein;

FIG. 6 is a more detailed partial cross sectional view of the mirror enclosure of FIG. 5 illustrating the mounting of the sensor within the mirror enclosure;

FIG. 7 is a view of a particular embodiment of an indicator for providing imminent icing enunciation to a vehicle operator;

FIG. 8 is a block diagram of the processing circuitry of FIG. 1 which interprets the input from the sensor;

FIG. 9 is a structure diagram of the decision levels employed in a particular embodiment of the invention; and

FIGS. 10-13 are graphs showing input consideration factors in determining icing potential.

### DETAILED DESCRIPTION

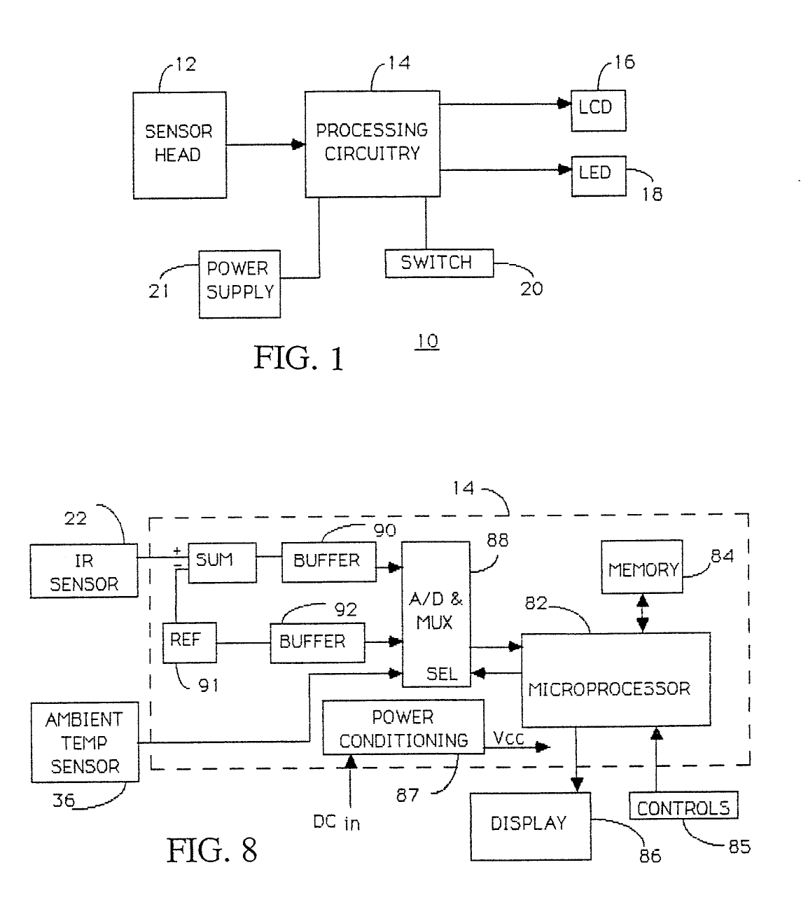

Infrared (I.R.) energy, which is radiation in a region of the electromagnetic spectrum having a wavelength between 0.5 and 20 micrometers, also referred to as the near-infrared and intermediate-infrared regions, is emitted by all objects having a temperature greater than absolute zero (−273° C.). The infrared energy radiated by an object at a given temperature is characterized by the term emissivity, which is the ratio of energy radiated by the given object to the energy emitted by a perfect radiator. Materials typically used for roadway surfaces, asphalt and concrete, have emissivity values of close to 1 (e.g., 0.9) which enables application of the present invention to sense the surface temperature of roadway surfaces, for example, based on radiated energy. Accordingly, referring to FIG. 1, a block diagram of an imminent icing system 10 according to the present invention, the system comprises an infrared sensor head 12 which is connected to processing circuitry 14. Processing circuitry 14 provides output to display modules which may comprise, for example, a liquid crystal display 16 or light emitting diode 18 or other suitable indicator. An on/off switch 20 controls operation of the apparatus. Operational power for the system is obtained from power supply 21.

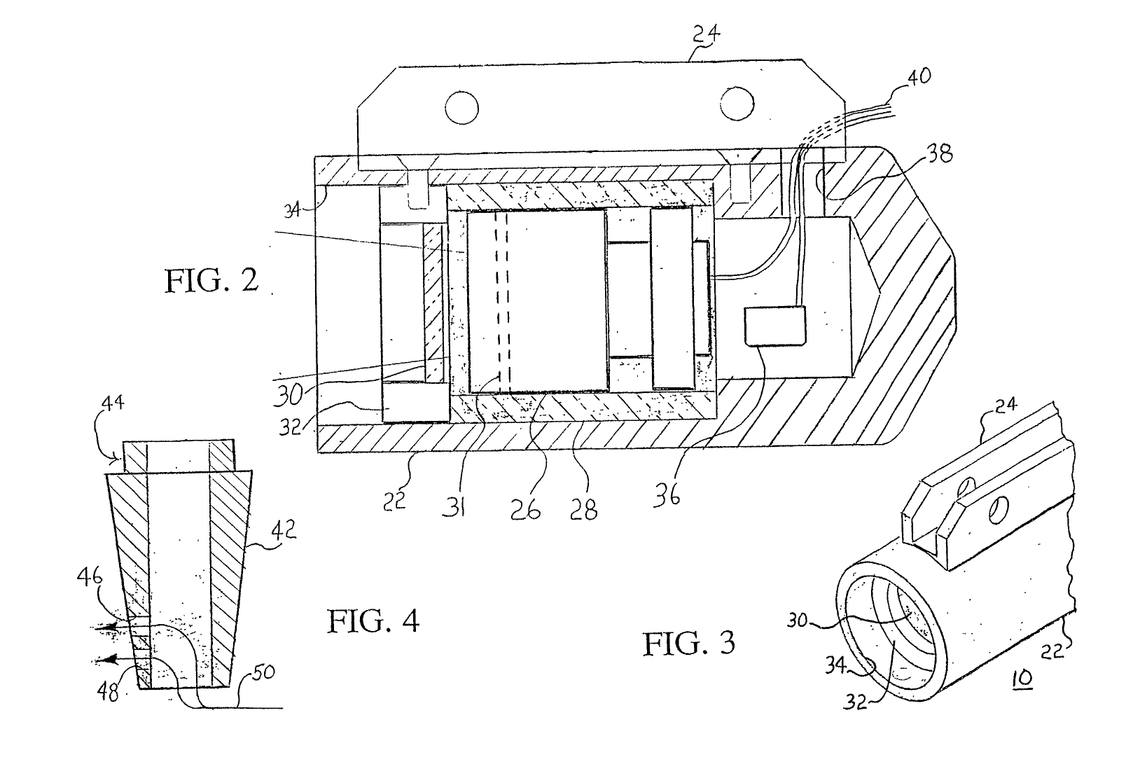

Referring now to FIG. 2, a cross sectional view of a particular embodiment of the sensor head 12 of FIG. 1, it may be observed that the sensor comprises an enclosure 22 which has a mounting flange 24 attached thereto to enable mounting at a particular use site. Positioned within the body enclosure 22 is an infrared optic head assembly 26 which is held in place by thermal/mechanical isolation member 28, which provides a secure engagement between the infrared sensor and the body 22 while also providing thermal and mechanical isolation between the sensor and the body. The body 22 is open at one end thereof and sensor 26 is oriented such that infrared radiation is received to the sensor via the opening in the body. Positioned between the opening and the sensor is a window 30 which assists in preventing contamination of the sensor 26 and also, in the illustrated embodiment, provides a bandpass filtering function to limit the energy reaching the sensor to a desired band. In the illustrated embodiment, the window comprises a zinc selinide window which has a pass band of approximately 5-20 micrometers wavelength. The window 30 is held in position via bezel 32 which is annular in configuration so as to fit within the opening 34 in mounting enclosure 22. It will be understood that while in the illustrated embodiment the enclosure is substantially cylindrical in shape, other shapes may be envisioned with attendant changes in the shape and configuration of the bezel, window and the thermal/mechanical isolation member. Also, enclosed within body 22 is a temperature sensor 36 which detects the ambient temperature of the air and infrared sensor so as to provide temperature compensation which is used to enable accurate readings from the infrared sensor without interference as a result of the ambient temperature of the sensor itself. A wiring hole 38 is provided in the body 22 to enable sensor wires 40 to pass from the infrared sensor 26 and/or temperature sensor 36 to processing circuitry 14 (FIG. 1).

The infrared sensor 26 also suitably includes a focusing member 31 therewithin, illustrated in phantom in FIG. 2. The focusing member suitably comprises a refractive lens, for example, a plano-convex lens, which allows focusing of the infrared radiation so as to provide sensing of radiation from a surface at a specific distance from the sensor. The focusing element may alternatively be a reflective type focusing system with attendant changes in the orientation of the sensor 26 wherein a convex mirror reflects the energy back to the sensor portion. The focusing element for some applications may be deleted allowing for an unaltered energy field input to the sensor.

Referring to FIG. 3, which is perspective view of a portion of the apparatus 10 according to the present invention, it may be observed that in the preferred embodiment, the sensor body 22 is substantially cylindrical in shape with a circular opening 34. Annular bezel 32 and window 30 are also visible. The mounting bracket 24 as illustrated in FIG. 3 is channel shaped and includes apertures therein for receiving mounting hardware to enable mounting to a vehicle or the like.

The infrared sensor 26 can comprise, for example, an OS51 I/R optic head assembly distributed by Omega, or the like, while the window 30 comprises a zinc selinide window available from IR Products Company. Other infrared compatible material may be substituted for the zinc selinide window. The particular infrared sensor portion comprises a thermopile core or other pyroelectric type infrared sensor. The sensor body 22 is suitably of machined aluminum, as is mounting bracket 24 and bezel member 32. The thermal/mechanical isolation is optional and may comprise, for example, a foam sleeve.

In use, the sensor body 22 is mounted to an external portion of the vehicle, for use in applications for determining roadway icing conditions. As an example, the sensor body may be mounted to a support member of an external mirror which is attached to, for example, the cab of a truck. The sensor is mounted with opening 34 oriented in a downwardly direction, so as to provide an unobstructed view of the roadway surface for the infrared sensor 26. The use of the focusing element and proper placement of the sensing body at a specified height above the road surface enables infrared energy emitted by the surface portion of the roadway to be detected, while minimizing detection of stray infrared radiation from other objects or surfaces.

Referring now to FIG. 4, a cross sectional view is shown of a protective device which is adapted to mount to the sensor head body. The protective device comprises a frusto-conical shaped member 42 with an aperture extending the length thereof and which is open at both ends so as to provide a viewing port therethrough. The member 42 is cut in stepwise fashion at a base end thereof so as to provide a mating portion 44 which fits in securely engaging fashion within the annular opening 34 of sensor body 22. Two apertures 46 and 48 are provided crossways through the face of the frusto-conical member so as to intersect the central bore of the member substantially perpendicularly thereto. When installed, the protective member channels airflow across the distal end thereof through the two openings 46 and 48, so as to cause airflow which occurs as a result of movement of the vehicle to which the sensor is mounted, to pass along line 50 and through openings 46 and 48. This flow provides an air curtain effect which substantially reduces the likelihood of debris from passing the entire length of the central bore of member 42 and striking and possibly obscuring window 30. Thus, window 30 is maintained relatively unobscured by dirt or other debris. It will be understood that member 42 is optional as dictated by the particular operating conditions.

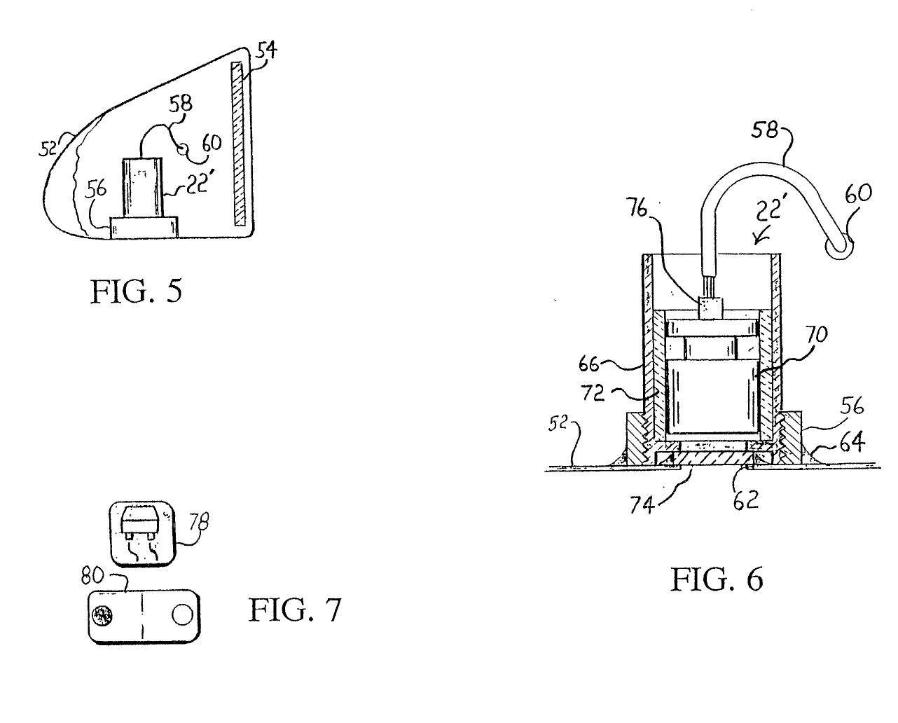

FIG. 5 is a cutaway view of a mirror enclosure housing of a typical passenger car, illustrating an alternative placement of the icing sensor of the present invention, when used in conjunction with passenger vehicles, for example. The mirror housing 52 is typically aerodynamically shaped and supports mirror 54 at the trailing edge thereof. Located within the interior of the mirror enclosure is sensor 22′, which is received within mount 56 at the bottom wall of the mirror enclosure. Wiring bundle 58 exits the sensor 22 and is passed out of the body of the mirror enclosure via aperture 60.

FIG. 6 illustrates in partial cross section further details of the structure of sensor 22′ and mounting block 56 of FIG. 5. As may be observed in FIG. 6, the bottom wall of mirror housing 52 has an opening 62 formed therein centrally of the position of sensor 22′, thereby affording a viewing aperture for the infrared sensor. Mounting member 56 is suitably secured to the wall of the mirror housing via adhesive 64, or other suitable means. The mounting member in the particular embodiment has an annular interior and is threaded so as to engage with corresponding threads on the outer surface of housing 66. The sensor is enclosed within housing 66. In a similar construction to the sensor of FIG. 2, sensor 22′ includes an infrared detector assembly 70 which includes a focusing element and infrared thermopile mounted within sensor housing 66 via thermal and mechanical isolation sleeve 72 which suitably comprises a foam sleeve. A window 74 substantially seals the opening 62 to prevent moisture or debris from entering the interior of the mirror housing, while still enabling infrared radiation to pass to the sensor. Window 74 suitably comprises a zinc selinide window which also serves as a filter to provide a pass band of a given infrared radiation wavelength band. Mounted atop the sensor 70 is ambient temperature sensor 76 which serves to compensate for the ambient temperature so as to allow proper correlation of the infrared sensor output, since the sensor output varies with changes in ambient temperature. Cable 58 communicates the voltage generated by the infrared sensor and ambient temperature sensor for further processing as discussed hereinbelow. The embodiment of FIGS. 5 and 6 thus provides an icing indicator suitable for use in, for example, passenger vehicles wherein the sensor is essentially concealed, to provide sensing while not altering the appearance of the vehicle.

FIG. 7 illustrates a display enunciator suitable for use with the present invention. This enunciator would typically be mounted at the dashboard of a vehicle when used, for example, with automotive applications. The enunciator includes a display 78, which in the illustrated embodiment, employs a depiction of an automobile with swerving tracks, to indicate icing conditions. The display 78 is suitably lighted when it is determined that icing conditions are imminent, as discussed herein-below. The installation also includes a rocker-type switch 80 corresponding to on/off switch 20 of FIG. 1, which enables the device to be activated or deactivated by toggling of the switch to the left or to the right. The switch may suitably be backlighted to indicate when the system is active.

Referring now to FIG. 8, a block diagram of processing circuitry block 14 of FIG. 1, the arrangement and operation thereof will be described in greater detail. The processing circuit block comprises a microprocessor 82 which includes memory 84 for storing the operational instructions and data therefor. Memory 84 may comprise a RAM/ROM combination, EERAM, or the like. The microprocessor interfaces with display 86 which may comprise, for example, the particular display 78 of FIG. 7, or any suitable indicator. The display may also include-a digital readout of air and road surface temperatures or other suitable message. Operator commands are supplied to the processor via controls 85, which may include on/off switch 20 (FIG. 1) or the like. Power for the various components is supplied by power conditioning block 87 which takes a DC voltage input (DCᵢₙ) from, for example, a battery. Data from IR sensor 22 is fed to a plus (+) side of a summing circuit 89, while the minus (−) side of summing circuit 89 is connected to reference block 91 (REF). The output from summing circuit 89 and reference block 91 are supplied, via buffers 90 and 92 to analog-to-digital converter/multiplexer block 88 (A/D & MUX). Output from ambient temperature sensor 36 is also received by A/D & MUX 88. The microprocessor receives input data from A/D & MUX 88, as selected by microprocessor control of the select lines (SEL) of the multiplexer.

In operation, sensor 22 generates a voltage output based on the amount of infrared radiation detected and, as altered by summing block 89 and buffer 90, is converted to digital values by A-to-D converter 88. Similarly, the ambient air temperature sensor 36 and the voltage output thereof which is representative of air temperature is also supplied to A-to-D converter 88 for conversion-to-digital values. Block 88 supplies a multiplexed output so as to provide the digitized infrared sensed data from block 22 and the digitized ambient air sensed data from block 36 in alternate fashion to microprocessor 82. The reference block 91 in conjunction with summing block 89 enables a precision measurement of the output of sensor 22.

In operation, the stored program and data in memory 84 includes operational software for the microprocessor so as to periodically sample the data from multiplexer 88 and to provide an indication of whether icing is imminent or not based on the input infrared sensor data and ambient air sensor data. This may be accomplished, for example, via use of look-up tables which hold empirically determined values correlating the sensed voltage values from infrared sensor 22 and air sensor 36 with actual surface temperatures. If the sensed temperature is below a threshold value, for example 35°, then an indication is provided to display 86 to illuminate, for example, the car icon 78 of FIG. 7. Also, an actual temperature value may also be displayed via an alphanumeric display, for example.

In an alternative embodiment, fuzzy logic is employed with rules embodied in memory 84 and interpreted by microprocessor 82 so as to provide a sophisticated analysis of road surface temperature versus air temperature. For example, if the air temperature has been steadily cold but the road surface is warm, the likelihood is that the road is warm due to radiant heating (e.g., from sunlight). In such a situation, shaded portions of the road are likely to be icy, so a warning is appropriate. Fuzzy logic refers to a superset of conventional logic, with modifications to include the concept of partial truths, wherein truth values may be on a continuum between entirely true and entirely false.

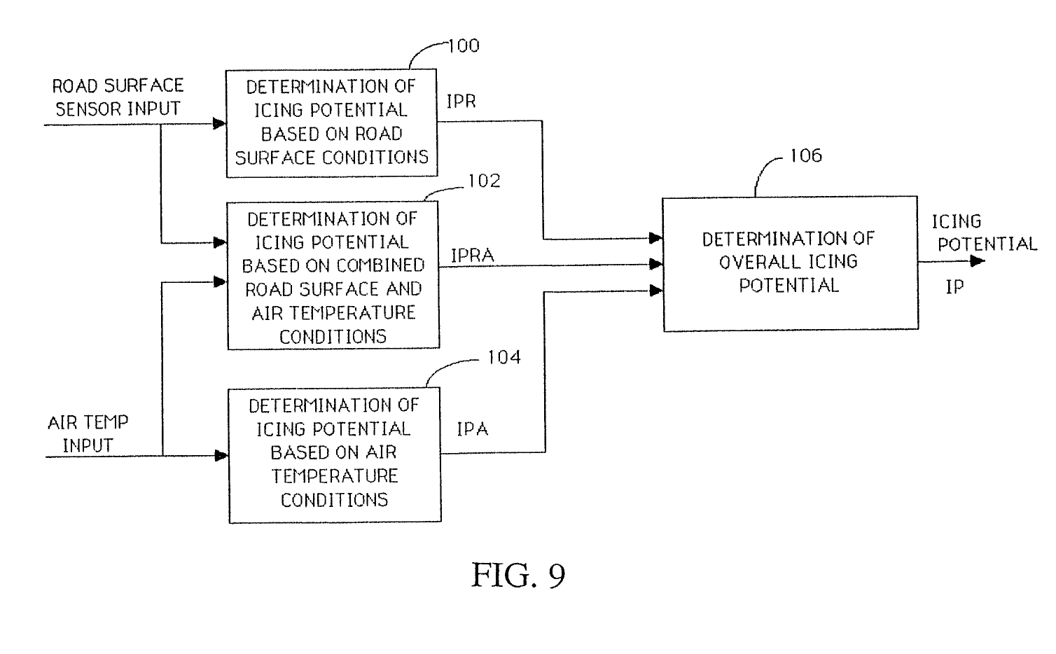

Referring now to FIG. 9, which is a structure diagram of the decision making levels employed in one embodiment of the invention employing fuzzy logic, the road surface sensor input and the temperature input are employed in three separate decision making blocks, wherein in block 100 a determination is made of icing potential based on the road surface condition as sensed by the road surface sensor input; in block 102, a determination is made of a icing potential based on a combination of the road surface input and the air temperature sensor input; and in block 104 a separate determination is made of icing potential based on the air temperature conditions alone as sensed by the temperature sensor 76 of FIG. 6, for example. The three determinations of each of blocks 100, 102 and 104 are then provided to a separate, fourth determination block 106 which makes a prediction of overall icing condition based on the three separate icing potential decisions. This overall decision, of icing potential is then provided to display 86 (FIG. 8). The display may be provided in multiple versions, wherein one display is a bi-state display of either on or off, indicating icing not likely or icing likely; an alphanumeric display wherein icing likelihood is classified as none, low, moderate or high; or the like. The decision may also be displayed in conjunction with temperature indications which provide a road surface temperature as well as an ambient air temperature based on the sensor inputs.

The following fuzzy logic rules system is used to process the data and produce the output decision of ice danger. The basic raw inputs are:

| 1. | Road surface temperature | | | |
|---|---|---|---|---|
| | a. | Warm road | (WARM) | greater than 40 deg F. |
| | b. | Cool road | (COOL) | centered at 35 deg F. |
| | c. | Cold road | (COLD) | less than 32 deg F. |

| 2. | Road surface temperature range | | | |
|---|---|---|---|---|
| | a. | Large changes | (LARGE) | greater than 5 deg F. |
| | b. | Small changes | (SMALL) | centered at 2 deg F. |
| | c. | No change | (NO) | less than 1 deg F. |

| 3. | Air temperature | | | |
|---|---|---|---|---|
| | a. | Warm air | (WARM) | greater than 40 deg F. |
| | b. | Cool air | (COOL) | centered at 35 deg F. |
| | c. | Cold air | (COLD) | less than 32 deg F. |

| 4. | Air temperature rate of change | | | |
|---|---|---|---|---|
| | a. | Rapid increase | (RAPID INCREASE) | increasing at |
| | | | | greater than |
| | | | | .25 deg F./min |
| | b. | Stable | (STABLE) | centered at |
| | | | | no change |
| | c. | Rapid decrease | (RAPID DECREASE) | decreasing at |
| | | | | greater than |
| | | | | .25 deg F./min |

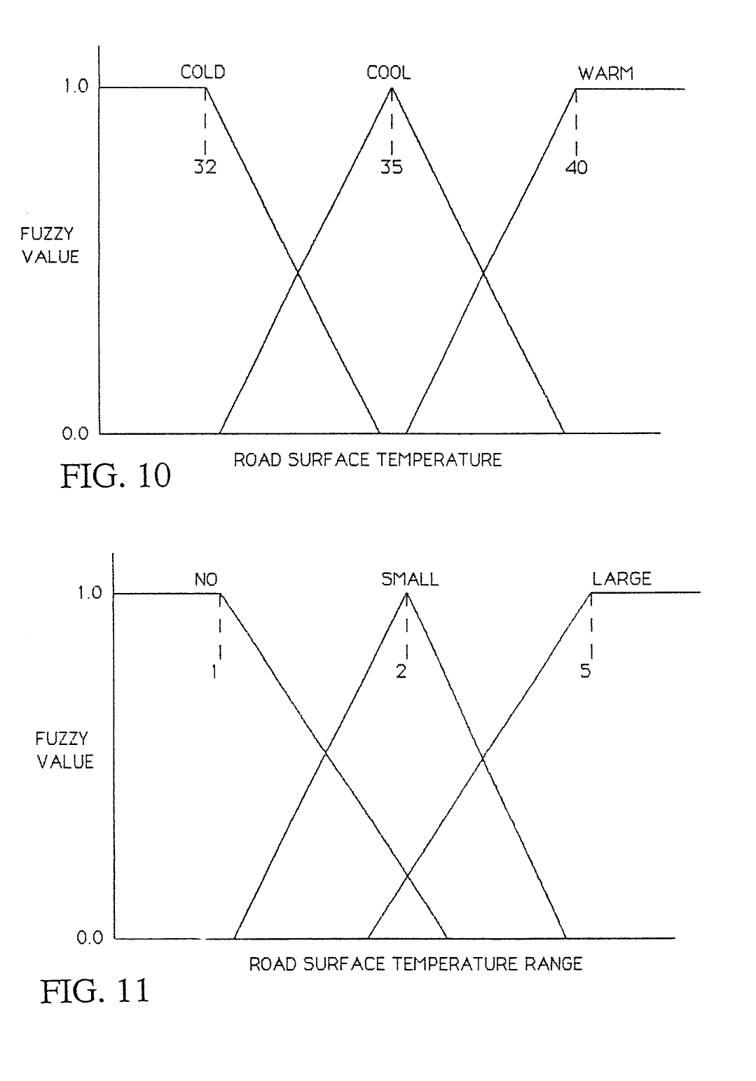

FIGS. 10 and 11 are graphs illustrating the fuzzy logic consideration based on the road surface temperature and road surface temperature range. For example, a road surface temperature of 32° or less has a cold value of 1.0 and cool and warm values of 0 (entirely false). As temperature increases, the value of cold decreases while “cool” increases towards 1.0 (entirely true), for example.

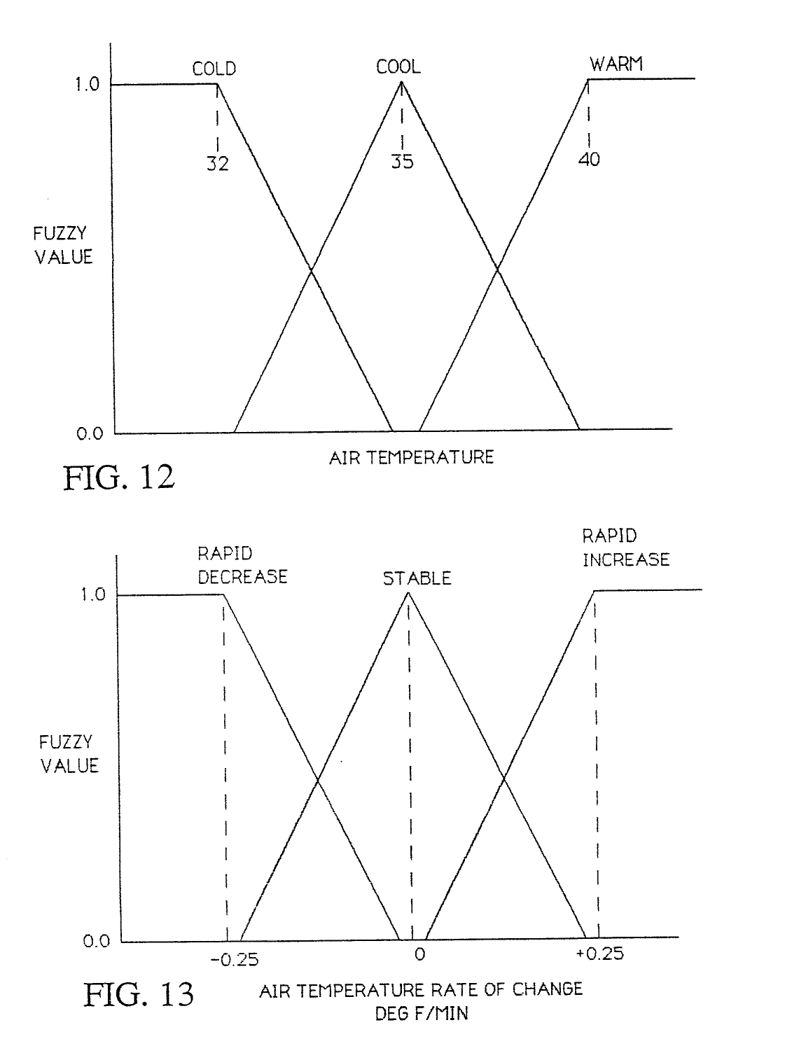

FIGS. 12 and 13 show the corresponding truth values (or fuzzy values) for the air temperature and air temperature rate of change factors.

Rules for determining icing potential due to road temperature as implemented by decision block 100 are as follows:

An output ice potential due to road (IPR) is generated by block 100 and has a value of

1. STRONG

2. MODERATE

3. NONE

The rules for icing potential due to road temperature are as follows:

a. If road is WARM: then NONE

a. If road is COOL and LARGE: then STRONG

b. If road is COOL and SMALL: then MODERATE

b. If road is COOL and NO: then NONE

a. If road is COLD: then STRONG

The rules for determining icing potential due to air temperature as implemented by decision block 104 are as follows:

An output icing potential due to air (IPA) can be one of three values

1. STRONG

2. MODERATE

3. NONE

The specific rules for icing potential due to air are as follows:

a. If air is WARM and RAPID INCREASE: then NONE

d. If air is COOL and RAPID INCREASE: then NONE

e. If air is COOL and STABLE: then NONE

f. If air is COOL and RAPID DECREASE: then STRONG

d. If air is COLD and RAPID INCREASE: then MODERATE

e. If air is COLD and STABLE: then STRONG

f. If air is COLD and RAPID DECREASE: then STRONG

The rules for determining icing potential due to road and air conditions in combination are as follows:

The output of ice potential due to road and air (IPRA) generated by block 102 can comprise one of three values:

1. STRONG

2. MODERATE

3. NONE

The particular rules for generating ice potential due to road and air are:

a. If road is WARM and air is WARM: then NONE

b. If road is WARM and air is COOL: then NONE

b. If road is WARM and air is COLD: then STRONG

b. If road is COOL and air is WARM: then NONE

b. If road is COOL and air is COOL: then MODERATE

b. If road is COOL and air is COLD: then STRONG

b. If road is COLD: then STRONG

The ultimate ice danger decision is accordingly based on the results of examining each input from blocks 100, 102 and 104, wherein each input may comprise the value of NONE, meaning no ice danger from that particular factor; MODERATE, indicating that the ice danger is moderately high from that particular factor and STRONG, which indicates that there is a high likelihood of icing based on that determined factor. The ultimate output of whether icing danger is NONE, WARNING, or DANGEROUS is determined experimentally based on the various factor inputs. Alternatively, the system may be adaptive wherein when in particular driving conditions which are known to be icy or not icy, the operator may press a control which indicates the current condition and the system and stores that information to assist in future iciness determinations.

The final output of overall icing potential (IP) produced by block 106 can be one of the following values:

Ice danger is

a. NONE

b. WARNING

c. DANGEROUS

In the embodiment employing the display indicator of FIG. 7, a DANGEROUS result may be conveyed to the vehicle operator by blinking the indicator on and off at a rapid rate. On the other hand, if icing potential is only WARNING, the indicator may be lighted in a continuous manner. Finally, if the icing potential is determined to be NONE, the indicator is left unlighted.

The rules for generating the final icing potential decision are as follows:

| | IPA | | IPR | | IPRA | | IP |
|---|---|---|---|---|---|---|---|
| a. | NONE | and | NONE | and | X | then | NONE |
| a. | NONE | and | MODERATE | and | X | then | NONE |
| a. | NONE | and | STRONG | and | X | then | WARNING |
| a. | MODERATE | and | NONE | and | NONE | then | WARNING |
| a. | MODERATE | and | NONE | and | MODERATE | then | WARNING |
| b. | MODERATE | and | NONE | and | STRONG | then | DANGEROUS |
| a. | MODERATE | and | MODERATE | and | NONE | then | WARNING |
| a. | MODERATE | and | MODERATE | and | MODERATE | then | WARNING |
| b. | MODERATE | and | MODERATE | and | STRONG | then | DANGEROUS |
| a. | MODERATE | and | STRONG | and | X | then | DANGEROUS |
| a. | STRONG | and | NONE | and | NONE | then | WARNING |
| a. | STRONG | and | NONE | and | MODERATE | then | WARNING |
| b. | STRONG | and | NONE | and | STRONG | then | DANGEROUS |
| a. | STRONG | and | MODERATE | and | NONE | then | WARNING |
| a. | STRONG | and | MODERATE | and | MODERATE | then | WARNING |
| b. | STRONG | and | MODERATE | and | STRONG | then | DANGEROUS |
| a. | STRONG | and | STRONG | and | X | then | DANGEROUS |

It will be understood that in certain cases, the input value based on combined air and road factors (denoted by an “X” in the logic table) from block 102 is not considered, because the air and road factors alone are sufficient to determine icing imminence.

The imminent icing condition enunciator according to the present invention is also adaptable for other applications. For example, the invention is suitably useful in aircraft applications, wherein the runway surface conditions may be instantaneously communicated to a pilot prior to and upon landing, enabling the pilot to be aware of whether icing may be present on the runway surface to avoid surprise from unanticipated runway icing.

By revising the optical focusing from the sensor of the present invention and changing the I/R filter element to not exclude water vapor, it is possible to develop a sensor that will detect imminent icing conditions in flight. Accordingly, an improvement is provided over the outside air temperature sensor. When the aircraft is in clear air, the signal from the sensor of the present invention drops off. Temperature data is displayed only when the aircraft has penetrated an environment of cloud, fog, rain, ice or snow. This is very useful information during a night flight, for example, when pilots are unable to assess icing conditions.

When icing conditions are imminent, the in-flight icing detector of the present invention will provide warning to the pilot or crew. Aircraft de-icing equipment can then be activated early rather than later when icing becomes noticeable and accumulation is in process. Early de-icing is advantageous since de-icing requires aircraft engine power at a time when maximum engine power use is important as ice deposits can begin to degrade the intended wing lift-to-drag ratio.

Other environmental factors may also be sensed and factored into the decision making process. For example, the presence of moisture can be detected and used to further govern the resultant icing potential determination. In automobiles, the presence of moisture on a roadway is detected by a change in audible noise from the vehicle tires. Digital signal processing of an audio input to the microprocessor of FIG. 8 is one method of accomplishing this.

While plural embodiments of the present invention have been shown and described, it will be apparent to those skilled in the art that many changes and modifications may be made without departing from the invention in its broader aspects.

The appended claims are therefore intended to cover all such changes and modifications as fall within the true spirit and scope of the invention.

1. An imminent icing detector for determining icing conditions of a surface comprising:
infrared sensing means for detecting ambient infrared emission from the surface; and
processing means for receiving the detected ambient infrared emissions and for determining the likelihood of icing conditions of the surface based on the received detected ambient infrared emissions.

2. An imminent icing detector according to claim 1 further comprising ambient temperature sensing means, wherein said processing means receives the sensed ambient temperature and employs said sensed ambient temperature in conjunction with the detected ambient infrared emission for determining the likelihood of icing conditions.

3. An imminent icing detector according to claim 1 wherein said infrared sensing means comprises:
an infrared sensor; and
a focusing system for providing a focused infrared image to said infrared sensor to enable selective perception of ambient icing conditions of a given surface location.

4. An imminent icing detector according to claim 3 wherein said focusing system comprises a refractive focusing system.

5. An imminent icing detector according to claim 3 wherein said focusing system comprises a reflective focusing system.

6. An imminent icing detector according to claim 1 further comprising an indicator for conveying the determined likelihood of icing conditions to a user.

7. An apparatus for detecting icing conditions of a road surface comprising:
a sensor in spaced relation to the road surface for detecting ambient infrared radiation emissions from the road surface;
a focusing element for focusing infrared ambient infrared radiation emissions from the road surface to said sensor;
a filter for substantially limiting the energy reaching said sensor to a desired infrared wavelength range;
an ambient temperature sensor to detect the ambient temperature of said sensor to enable temperature compensation;
processing means for receiving output from said infrared sensor and said ambient temperature sensor and for determining the temperature of the road surface and predicting the likelihood of road surface icing.

8. An apparatus for detecting icing conditions of a road surface according to claim 7 wherein said focusing element comprises a refractive focusing system.

9. An apparatus for detecting icing conditions of a road surface according to claim 7 wherein said focusing element comprises a reflective focusing system.

10. An apparatus for detecting icing conditions of a road surface according to claim 7 wherein said filter comprises a zinc selinide window positioned between the road surface and said sensor.

11. An apparatus for detecting icing conditions of a road surface according to claim 7 further comprising a display for communicating the predicted likelihood of road surface icing.

12. A vehicle imminent icing detector for determining icing conditions comprising:
an imminent icing detector for determining icing conditions, said detector comprising,
infrared sensing means for detecting ambient infrared emission, and
processing means for receiving the detected ambient infrared emissions and for determining the likelihood of icing conditions based on the received detected ambient infrared emissions.

13. A vehicle according to claim 12 wherein said vehicle comprises an automobile and icing conditions of a roadway surface are detected.

14. A vehicle according to claim 12 wherein said vehicle comprises an aircraft and icing conditions of a runway are detected.

15. A vehicle according to claim 12 wherein said vehicle comprises an aircraft and temperature conditions of cloud, rain, ice or snow formations through which said aircraft is passing while in flight are detected.
